(19) United States
(12) Patent Application Publication
(10) Pub. No.: US 2018/0211572 A1
(43) Pub. Date: Jul. 26, 2018

(54) TIRE REPAIR DEVICE WITH PLACARD

(71) Applicant: ILLINOIS TOOL WORKS INC., Glenview, IL (US)

(72) Inventors: Mark T. Leuthe, Warren, MI (US); Bryan Smith, Rochester Hills, MI (US)

(73) Assignee: ILLINOIS TOOL WORKS INC., Glenview, IL (US)

(21) Appl. No.: 15/873,581

(22) Filed: Jan. 17, 2018

Related U.S. Application Data
(60) Provisional application No. 62/450,778, filed on Jan. 26, 2017.

(51) Int. Cl. G09F 7/06; B29C 73/02; G09F 3/00; G09F 7/12; G09F 23/00

(52) U.S. Cl. CPC G09F 7/06; B29C 73/025; G09F 3/00; B60S 5/04; G09F 23/00; G09F 2007/127; G09F 7/12

(57) ABSTRACT

A device for dispensing pressurized air and/or tire sealant. The device includes a placard attached to a device housing and including a plurality of warning messages in different languages. Each of the messages is a repetition of a same or similar warning translated into each of the official languages of the localities where the device is to be sold or used. A mechanical fastener can be used to connect the placard to the housing so that the placard lies on and parallel to a top surface of the housing.

### CROSS-REFERENCE TO RELATED APPLICATIONS

This application claims the benefit of and priority to U.S. Provisional Application, Ser. No. 62/450,778, filed 26 Jan. 2017. This U.S. Provisional Application is hereby incorporated by reference herein in its entirety and are made a part hereof, including but not limited to those portions which specifically appear hereinafter.

### BACKGROUND OF THE INVENTION

### Field of the Invention

The invention relates to a device for dispensing air and/or tire sealant from a canister by means of a pressure source, such as in which the pressure source and canister are contained in a housing, or for which the canister is separate from a compressor.

### Description of Prior Art

Tire repair devices are primarily used for introducing tire sealant into defective tires when a flat tire occurs and for sealing a defective tire. In these devices, a compressor presses compressed air into a canister of tire sealant and by means of corresponding dip tubes and/or inverted bottles, and the tire sealant is then pumped into the defective tire via a valve. After this, the valve can be switched so that the compressor can then inflate the tire. Standard functions from the prior art include either pumping only air in order to inflate balls or air mattresses or performing an air pressure check. In the repair function, the prior art is designed so that the introduction of sealant and air occurs in a single operation.

Current requirements (e.g., OHSA/GHS—Global Harmonization Standard) dictate that warning labels, typically attached to the top or front surface as adhesive labels, must have local languages represented on the product for the region where the product is going to be sold. For instance, if the product will only be sold in the U.S., English is the primary language, so only English needs to be used on warning labels. If the product would be sold in the U.S. and Spain, English and Spanish would need to be used on the warning label.

Vehicles including tire repair kits are often sold in multiple regions, with some devices requiring over 40 unique primary language variants. Due to this complexity and limited space to represent all of these languages, the customer may need to create multiple part numbers to create small subsets of languages on a label. This creates complexities at the customer, customer support, manufacturing, sub-supplier levels, etc. A multi-page booklet style label, can be used, but these are expensive to manufacture and may also require multiple part numbers needed by the customer depending upon the number of primary languages being addressed. Additionally, the warnings need to be clearly shown on the product (attached) and are typically the first thing a consumer sees.

There is thus a continuing need for an improved manner of affixing warnings and/or instructions requiring many different languages.

### SUMMARY OF THE INVENTION

The object of the present invention is to provide an alternate construction for warnings and/or instructions that need to be included with or applied to tire repair kits, and that condense multiple languages onto one label.

The present invention is directed to a label or placard attachable with respect to devices requiring messages in multiple languages. The placard of this invention can include the same or similar message in many languages, such as any number up to 40 or more languages, on one or more placard pages. The placard eliminates the need for multiple part numbers for ordering the device, thereby providing ordering, manufacturing, and inventory simplification, throughout the supply chain as well at the OEM. The placard can be attached to the device by any suitable attachment, such as, without limitation, a mechanical fastener, adhesive backing (such as on and along at least one placard edge), or a mechanical feature molded to one or more of the kit surfaces.

The invention includes a device for dispensing pressurized air and/or tire sealant. The device has a housing containing a pressure source, and a placard connected with respect to the housing. The placard includes a plurality of warning and/or instruction messages, wherein each of the plurality of messages is a warning and/or instruction in a different language.

The invention further includes a device for dispensing pressurized air and/or tire sealant, that has a housing containing a pressure source, a placard including a plurality of warning messages, and a mechanical fastener connecting the placard to the housing so that the placard lays on and parallel to a surface, such as a top surface, of the housing. Each of the plurality of messages is a repeat of the same or similar warning in a different one of each official language for each locality where the device is to be sold and/or areas defined by a customer.

### BRIEF DESCRIPTION OF THE DRAWINGS

The above-mentioned and other features and objects of this invention will be better understood from the following detailed description taken in conjunction with the drawings wherein:

FIG. 1 is a perspective view of a tire repair device according to one preferred embodiment of this invention;

FIG. 2 shows a mechanical placard connection according to one embodiment of this invention;

FIG. 3 shows a placard and label according to one embodiment of this invention;

FIG. 4 is a top view of a tire repair device according to one preferred embodiment of this invention;

FIG. 5 is a top view of the device of FIG. 4 with a placard; and

FIG. 6 is a top view of a tire repair device according to one preferred embodiment of this invention.

### DESCRIPTION OF PREFERRED EMBODIMENTS

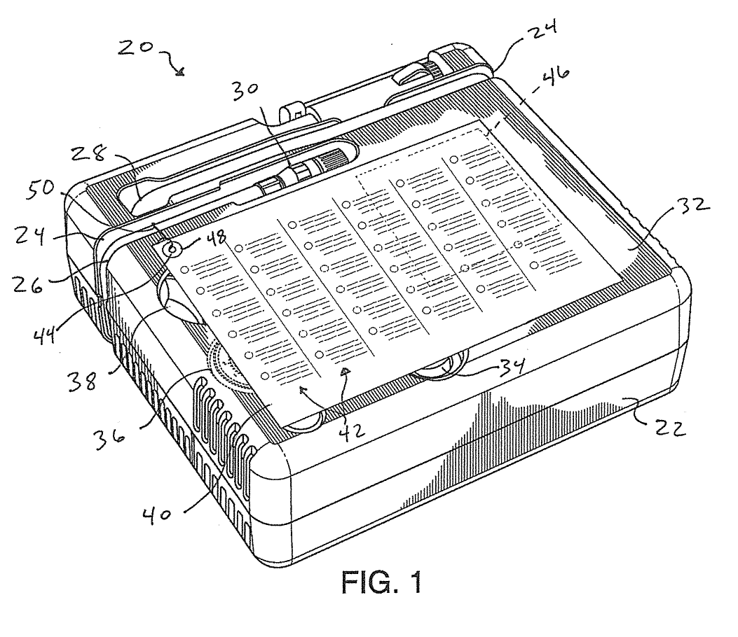

FIG. 1 shows a device 20 for dispensing pressurized air and/or tire sealant. The device includes a housing 22 containing a pressure source and including a slot 24 in the housing surface(s) for storing a hose 26 during non-use. In FIG. 1 the slot extends around the housing 22, allowing the hose 26 to wrap around the housing when in the slot 24. The hose 26 has a first end 28 in combination with the pressure source and/or a canister of sealant within the housing 22 and a second opposing end 30 adapted to connect to a tire stem for inflation and/or delivery of the sealant.

Functional elements are provided by corresponding openings in top surface 32 of the housing 22. These include, for example and without limitation, a switch 34 for switching the device on and off, a manometer 36 for measuring the pressure built up by a pressure source that will described below, and a rotary switch 38 for actuating a valve to switch from sealant to air.

A placard 40 is connected to the housing 22. The placard includes a plurality of printed messages 42 for consumer users of the device 20. The messages 42 can be warning messages or instructional messages. In preferred embodiments, each of the messages 42 is a repeat of a same or similar warning or instruction, and varying according to local requirements and/or translation idiosyncrasies, but in a different language. The placard 40 desirably includes the appropriate message 42 in the official language of each region or locality (e.g., country) where the device 20 is to be sold, alone or in combination with another product (e.g., a vehicle). The multi-lingual placard 40 allows for one part number for a device with a warning label, and eliminates the need for multiple part numbers for ordering the device with the desired label language, thereby providing ordering, manufacturing, and inventory simplification.

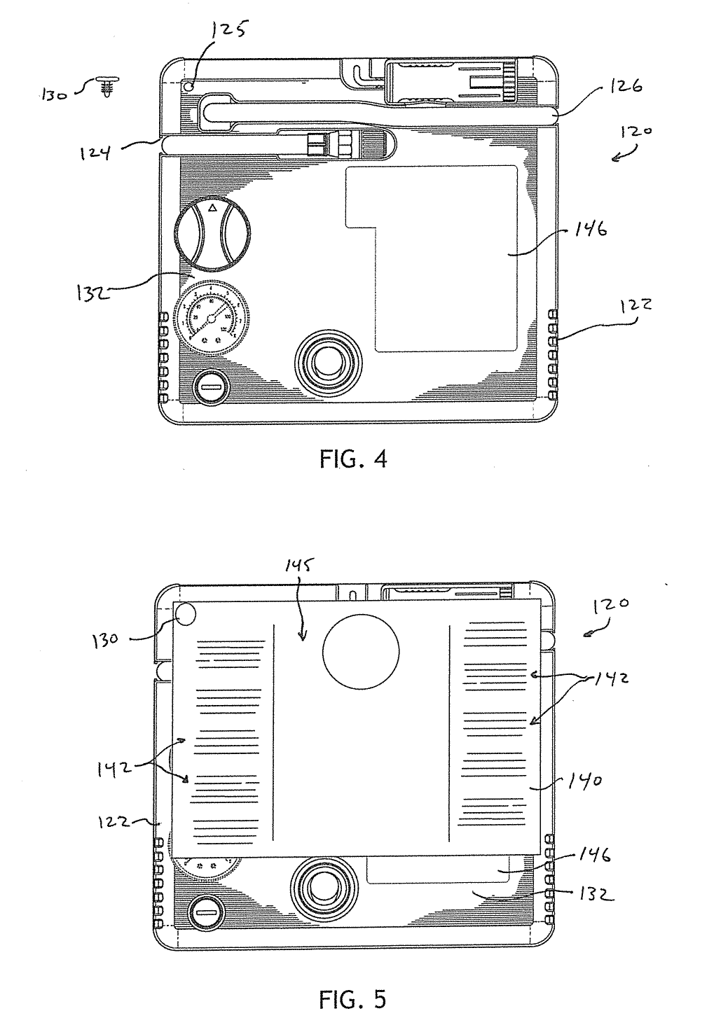

The placard 40 can be formed of any suitable material, such as a heavy stock paper laminated in plastic for durability. The size of the placard and the number of messages thereon can vary depending on need and/or the size of the device. In FIG. 1, the, placard 40 includes six columns of messages 42, each column including a message 42 in six different languages (36 total). However, the placard can include fewer messages, such as shown in FIG. 4, or more than forty messages. The placard can be printed on both sides or include multiple placard pages attached to the device or fastener, or to each other as a book.

In the embodiment of FIG. 1, the device 20 further includes an instruction label 46 adhered to the top surface 32 of the housing 20. The instruction label 46 can be any suitable adhesive-backed pressure sensitive label, fold-open label, or multipage book. As also shown in FIG. 3, the instruction label 46 is at least partially under the placard 40, or between the housing 22 and the placard 40, when the placard lays flat against the top surface 32. In this embodiment, the placard 40 includes warnings 42 in each of the plurality of languages and the instruction label 46 includes directions for use of the device 20.

The placard 40 can be removably or fixedly attached, directly or indirectly, to the device 20 by any suitable attachment, such as, without limitation, a mechanical fastener, adhesive backing on and/or along a placard edge, or a mechanical feature molded to one or more of the housing surfaces. In embodiments of this invention, such as shown in FIG. 1, The placard 40 includes a hole 44 for receiving the mechanical fastener 50. The hole 44 can optionally be reinforced by an eyelet 48, or other suitable ring around the circumference of the hole 44. The eyelet 48 can be any suitable support structure and/or material, such as commonly available paper/fibrous, plastic, or metal eyelet, ring, rivet, or grommet.

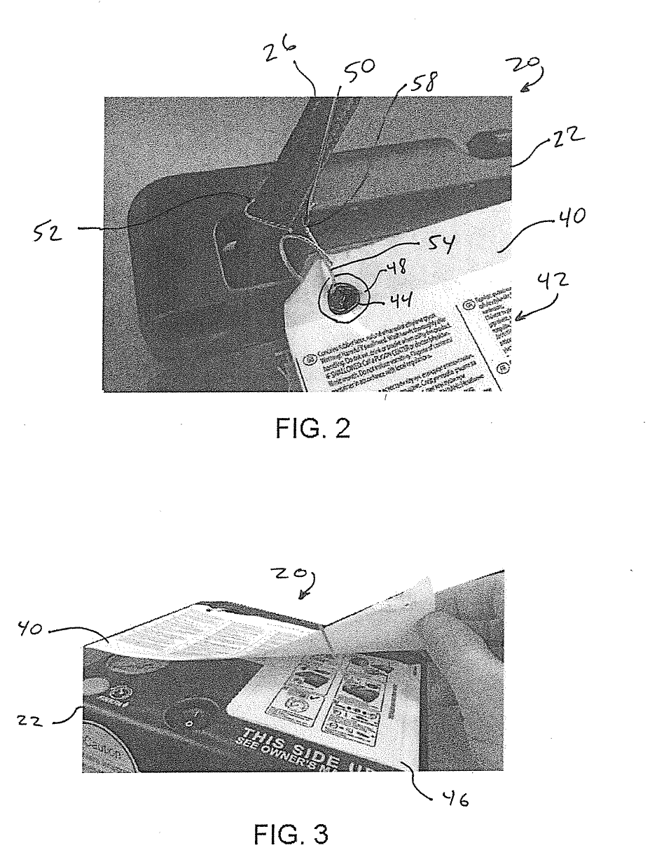

In the embodiment of FIG. 1, the mechanical fastener 50 connects the placard 40 to the hose 26. As shown in FIG. 2, the mechanical fastener 50 can include a first section 52 disposed around the hose 26 near or at the hose end 28, and a second section 54 extending through the hole 44 in the placard 40. In embodiments of this invention, the first section 52 can include a plastic or metal wire loop that is closed around the hose 26, and the second section 54 can include a second plastic or metal wire loop or ring with one side through the hole 44. In embodiments of this invention, the second section 54 is angled with respect to the first section 52, so that the placard 40 lays flat on or parallel to the housing top surface 32 when the hose 26 is placed in the slot. As can be seen in FIG. 3, the plane of the first section loop 52 is, at least approximately, turned 90° with respect to the plane of the second section 54. This configuration can be accomplished by a bend in the transition 58 between the two sections. As will be appreciated, various sizes, shapes, materials, and configurations are available for the fastener 50, and the sections 52 and 54, depending on need.

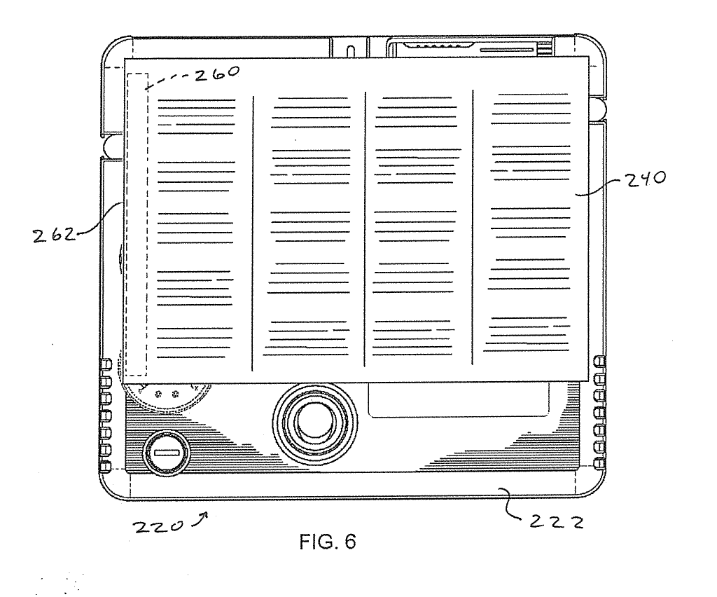

FIGS. 4 and 5 illustrate a mechanical fastener according to another embodiment of this invention, where the mechanical fastener is connected to and through a hole in each of the housing and the placard. FIG. 4 shows device 120 with a hose 126 and slot 124, similar to described above for FIG. 1, but with a hole 125 for receiving fastener 130. The hole 125 is formed in the top surface 132 of the housing 122 and has a suitable size (e.g., 5 mm) to receive the corresponding fastener 130. As shown in FIG. 5, the fastener 130 is inserted through a correspondingly sized hole in the placard 140 and into the housing hole 125 to hold the placard 140 flat against the top surface 132 of the housing 122. The fastener 130 can be any suitable push pin, clip, or rivet, formed of plastic or metal. As will be appreciated the size, shape, configuration and placement of the housing hole, placard, and placard hole can vary depending on need. FIG. 5 also shows an alternative placard configuration with two columns of messages 142 and a central section 145 including space for vehicle manufacturer information and/or logo, and any other warning symbols or pictorial representations. As will be appreciated the layout of text and logos on the placard can vary depending on need.

FIG. 6 illustrates a further embodiment of a device 220, using an adhesive material to attach the placard 240 to the housing 222. The adhesive is included in an adhesive strip 260 along placard edge 262. However, the placement of the placard and the amount and placement of the adhesive can vary, depending on need.

Thus the invention provides a device with an improved warning or instructional label. The placard of this invention, having required messages in multiple or all official languages of the locations where the device will be used or sold reduces the ordering and inventory issues for tire sealant kits in automobiles sold in multiple localities.

While in the foregoing specification this invention has been described in relation to certain preferred embodiments thereof, and many details have been set forth for purpose of illustration, it will be apparent to those skilled in the art that the device and placard are susceptible to additional embodiments and that certain of the details described herein can be varied considerably without departing from the basic principles of the invention.

1. A device for dispensing pressurized air and/or tire sealant, the device comprising:
a housing containing a pressure source; and
a placard connected with respect to the housing, and including a plurality of warning or instruction messages, wherein each of the plurality of messages is a warning or instruction in a different language.

2. The device of claim 1 further comprising a warning or instruction message in an official language for each locality where the device is to be sold and/or areas defined by a customer.

3. The device according to claim 2, further comprising an instruction label adhered to the housing between the housing and the placard, wherein the placard includes a warning in each of the plurality of languages and the instruction label includes directions for use of the device.

4. The device according to claim 1, wherein the placard is connected to the housing by a mechanical fastener or an adhesive.

5. The device according to claim 4, wherein the placard comprises a hole with a support eyelet for receiving the mechanical fastener.

6. The device according to claim 4, wherein the mechanical fastener is connected to and through a hole in each of the housing and the placard.

7. The device according to claim 4, wherein the mechanical fastener comprises a push pin, clip, or rivet.

8. The device according to claim 4, wherein the adhesive is disposed along an edge of the placard.

9. The device according to claim 1, further comprising a hose connected to the housing and/or the pressure source.

10. The device according to claim 9, wherein the housing includes a slot and the hose is insertable into the slot for storage.

11. The device according to claim 9, wherein the placard is connected to the hose by a mechanical fastener.

12. The device according to claim 11, wherein the mechanical fastener has a first section disposed around the hose and a second section extending through a hole in the placard, wherein the second section is angled with respect to the first section so that the placard lies parallel to the housing when the hose is placed in the slot.

13. A device for dispensing pressurized air and/or tire sealant, the device comprising:
a housing containing a pressure source; and
a placard including a plurality of warning messages, wherein each of the plurality of messages is a repeat of a same or similar warning in a different one of each official language for each locality where the device is to be sold; and
a mechanical fastener connecting the placard to the housing so that the placard lies on and parallel to a top surface of the housing.

14. The device according to claim 13, further comprising an instruction label adhered to the housing between the housing and the placard.

15. The device according to claim 13, wherein the mechanical fastener is connected to and through a hole in each of the housing and the placard.

16. The device according to claim 15, wherein the mechanical fastener comprises a push pin, clip, or rivet extending through the hole in each of the housing and the placard.

17. The device according to claim 13, further comprising a hose connected to the housing and/or the pressure source, wherein the placard is connected to the hose by the mechanical fastener.

18. The device according to claim 17, wherein the housing includes a slot and the hose is insertable into the slot for storage, the mechanical fastener has a first section disposed around the hose and a second section extending through a hole in the placard, wherein the second section is angled with respect to the first section so that the placard lays parallel to the top surface when the hose is placed within the slot.
